(19) United States
(12) Patent Application Publication
(10) Pub. No.: US 2006/0105792 A1
(43) Pub. Date: May 18, 2006

(54) Method and apparatus for proving push-to-talk services to non-push-to-talk enabled networks

(76) Inventors: Peter J. Armbruster, Chandler, AZ (US); Michael D. Sasuta, Mundelein, IL (US); Johanna A. Wild, Munich (DE)

Correspondence Address: INGRASSIA FISHER & LORENZ, P.C., 7150 E. CAMELBACK, STE. 325, SCOTTSDALE, AZ, 85251, US

(21) Appl. No.: 10/989,477

(22) Filed: Nov. 15, 2004

(51) Int. Cl. H04Q 7/20

(52) U.S. Cl. 455/517; 455/509

(57) ABSTRACT

A method for providing push-to-talk service between PTT enabled devices and non-PTT enabled devices is disclosed. First, the non-PTT enabled device is registered at a PTT interworking agent. Then, signaling data is received at an interface in a first format. The signaling data includes an identifier corresponding to one or more destination phones. Next, the signaling data in the first format is converted to a second signaling protocol at the PTT interworking agent. The push-to-talk signaling information is sent to a push-to-talk server and a destination address is located for each of the one or more phones associated with the signaling data. The signaling data is then routed to the one or more phones.

### TECHNICAL FIELD OF THE INVENTION

This invention relates to the field of telecommunications and, more particularly, to a method and apparatus for providing push-to-talk services to non-push-to-talk enabled networks.

### BACKGROUND OF THE INVENTION

An increasingly popular feature offered with cellular phone service is a push-to-talk (PTT) service. Push-to-talk is a two-way communication service that works like a “walkie-talkie” in that the conversations are half-duplex and, typically, the user holds down a button to talk and releases the button to listen. The popularity of PTT service is due in part to the fact that it allows a user to quickly communicate with groups of individuals.

Currently, PTT services are typically provided over a proprietary network. Since the use of a proprietary network hampers the widespread adoption of PTT services, push-to-talk over cellular (PoC) systems have been developed. PoC utilizes the existing cellular phone system with the addition of a PoC server to provide PTT service. In an exemplary PoC system, the initiator of a PTT call dials an identification number corresponding to the individual or group with whom the call initiator wishes to speak, holds down a push-to-talk button on the cellular phone and speaks. Alternatively, the initiator of the PTT call can select the name of an individual or group of individuals from an address book provided with the phone. The user's speech is digitized and converted into a series of data packets. Tnis process is typically done at the phone. The dialed identification number or selected address is included in signaling data, which is routed to the PoC server where the identification number can be matched with an identifier of the destination phone or phones. Typically, the identification number is matched with an IP address corresponding to the phone or phones to which the PTT call was sent. The packetized voice data is routed through a network, typically the Internet, to the destination phone or phones.

Thus PoC provides for push-to-talk service over non-proprietary networks. However, PoC systems do not allow for PTT calls between a PTT enabled network and a non-PTT enabled network such as a phone that is part of a circuit switched network (like a typical landline phone).

### SUMMARY OF THE INVENTION

In one embodiment of the present invention a method for providing push-to-talk service between PTT enabled device and non-PTT enabled devices is disclosed. First, the non-PTT enabled device is registered at a PTT interworking agent. Then, signaling data is received at the PTT interworking agent in a first format. The signaling data includes an identifier corresponding to one or more destination phones. Next, the signaling data in the first format is converted to a second format at the PTT interworking agent. The push-to-talk signaling information is sent to a push-to-talk server and a destination address is located for each of the one or more phones associated with the signaling data. The signaling data is then routed to the one or more phones.

In another embodiment, an interface for enabling push-to-talk service between PTT enabled devices and non-PTT enabled devices is disclosed. The interface comprises an input for receiving signaling information and voice data from the non-PTT enabled device. Also included is a means for converting the signaling information to a second signaling protocol and a means for converting the voice data to packetized voice data. The interface also includes an output for sending the signaling information in the second signaling protocol.

### BRIEF DESCRIPTION OF THE DRAWINGS

The present invention will hereinafter be described in conjunction with the following drawing figures, wherein like numerals denote like elements, and:

FIG. 1 is a block diagram of a system for providing PTT service between push-to-talk enabled devices and non-push-to-talk enabled devices in accordance with the teachings of the present invention;

FIG. 2 is a block diagram of a PTT interworking agent in accordance with the teachings of the present invention; and

FIG. 3 is a flowchart illustrating an exemplary method for providing PTT interoperability between PTT enabled devices and non-PTT enabled devices in accordance with the teachings of the present invention.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of PTT systems and that the system described herein is merely one exemplary application for the invention.

In the following description a circuit switch device, such as a plain old telephone system (POTS) telephone, is discussed as an exemplary embodiment of the present invention. The teachings of the present invention also apply to other non-PTT enabled devices and systems, circuit switched or packet switched.

A push-to-talk system compatible with non-PTT enabled devices, according to various aspects of the present invention, comprises any system for allowing a non-PTT enabled device, such as a circuit switched device, to make and receive PTT calls. For example, in an embodiment of the present invention, a user of a PTT enabled cellular phone can include a circuit switched device, such as a landline phone, in a PTT call. Additionally, a non-PTT device, such as a circuit switched device, can originate PTT calls.

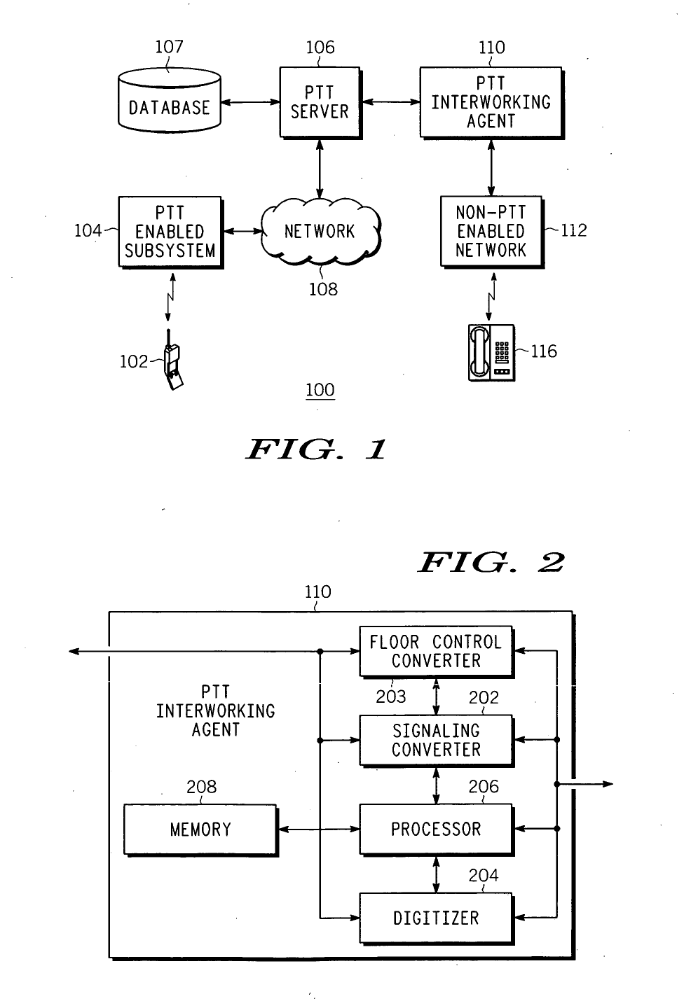

For example, PTT system 100 of FIG. 1 comprises a PTT enabled subsystem 104 coupled to a PTT server 106 via a network 108. The PTT server 106 couples to a non-PTT enabled network 112 via a PTT interworking agent 110. In one embodiment, non-PTT enabled devices 116 are coupled to the non-PTT enabled network 112 while PTT enabled devices 102 are coupled to the PTT enabled subsystem 104.

PTT enabled subsystem 104 handles voice calls from one or more PTT enabled devices 102. PTT enabled subsystem 104 also supports push-to-talk services such as push-to-talk over cellular (PoC). Support for push-to-talk services includes support for the routing of signaling data, which includes the identification of the party or parties that are to participate in the PTT calls, and for the routing of packetized voice data that is typically routed via network 108. In one embodiment, the PTT enabled subsystem 104 is the GSM cellular system. The GSM cellular system supports the transmission of IP packets of data, including digitized voice data from a push-to-talk call, through network 108 via an IP data network gateway.

Network 108 receives and transfers data packets including, in one embodiment, digitized voice data from a push-to-talk call. Network 108 can be one of many different networks, such as the Internet, a corporate Intranet, a wireless local area network and the like. In one embodiment, PTT enabled subsystem 104 couples to network 108 for the transfer of Internet Protocol (IP) data packets.

PTT server 106 couples to the network 108 for receiving signaling information and data packets containing digitized voice data from a push-to-talk call. PTT server 106 can include database 107 containing information about each registered PTT user. For example, the database 107 may contain data that allows for the routing of signaling data and voice data. In one embodiment, the database 107 includes a table associating identification numbers of one or more PTT users and information allowing the signaling information and the voice data to be routed to the PTT users, such as an IP address for each PTT user's phone. In a preferred embodiment of the present invention, the PTT server 106 is unchanged from a PTT server that interconnects only PTT enabled systems. That is, as far as the PTT server 106 is concerned, there is no difference between the data received from the PTT enabled subsystem 104 and the output of the PTT interworking agent 110.

The PTT interworking agent 110, according to aspects of the present invention includes any device capable of translating signaling data generated by the non-PTT enabled device 116 to a PTT server protocol and converting signaling data generated by a PTT enabled device into a protocol understandable by the non-PTT enabled device 116. In one embodiment of the present invention, PTT interworking agent 110 also converts analog voice into digitized voice and places the digitized voice into packets. PTT interworking agent 110 can also convert digitized voice to analog voice for presentation to non-PTT enabled network 112.

For example, and with reference to FIG. 2, an exemplary PTT interworking agent 110 includes a signaling converter 202, a floor control signal converter 203, a voice digitizer 204, and a processor 206. The processor 206 is coupled to the signaling converter 202, the voice digitizer 204 and a memory 208.

Signaling converter 202 converts signals generated by the non-PTT enabled device 116. The signals are, in one embodiment, at least part of the signaling information used for setting up PTT calls. In an exemplary embodiment, the non-PTT enabled device 116 is a circuit switched device that generates dual tone multi-frequency (DTMF) signals when the various phone number buttons are pushed. Also, in one embodiment, the PTT server 106 utilizes the well known Session Initiation Protocol (SIP) as a signaling protocol. Therefore, signaling converter 202, in one embodiment, converts DTMF signals from a circuit switched device, such as a series of numbers dialed on a landline phone, to SIP signals which are interpreted at the PTT server 106. For example, a user of a landline phone can enter a sequence of numbers representing the identification number of a user or users to which the user of the landline phone wants to include in a push-to-talk call. The identification number is converted from DTMF signals to SIP signals and the identification number, now in the SIP format, is sent to the PTT server 106. Additionally, SIP signals, generated by PTT enabled devices 102 or at the PTT server 106, can be converted into DTMF signals using signaling converter 202. While DTMF is discussed as an exemplary signal produced by a POTS device, any signal protocol used by a non-PTT enabled device 116 can be converted by signaling converter 202 for use with PTT server 106.

Floor control signal converter 203 converts floor control commands entered on a non-PTT enabled device 116 to a proper format for use by PTT server 106 and vice versa. In one embodiment of the present invention, at the PTT server 106 the floor control commands, in conjunction with floor control arbitration logic, determine which of the call participants is the talking party and which are the listening party or parties. For embodiments where the non-PTT enabled device 116 is a POTS telephone, the floor control signal converter 203 converts DTMF signals to a format useable by the PTT server 106. In one embodiment, the format is the well known Real-time Transmission Control Protocol (RTCP). However, other protocols besides DTMF may be used by non-PTT enabled devices 116 and they may be converted to a protocol different than RTCP, depending on the requirements of the PTT server 106.

PTT enabled users typically have a button on their phone that is pressed when the party desires to speak and released when the party wants to listen (often referred to as the “push-to-talk” button). For non-PTT enabled devices 116, such as POTS phones, an existing button on the phone, such as the “star” (“*”) key or “pound” (“#”) key, can be used to simulate the push-to-talk button. Alternatively, a sequence of button presses can be used to indicate the push-to-talk button is active and a second sequence can be used to indicate the push-to-talk button is released.

In one embodiment, floor control information is sent using RTCP signals because RTCP signals are sent with the voice data packets and not with call setup signals, resulting in quicker and more efficient floor control. However, while floor control information is preferably sent using RTCP, floor control information could be sent with call setup signals using a protocol like SIP. If SIP is used as the floor control command protocol, it would eliminate the need for floor control signal converter 203.

Voice digitizer 204 can be any device capable of converting analog voice to digitized voice as well as converting digitized voice back to analog voice. In one embodiment, voice digitizer 204 can also serve as a packet assembly device and assemble the digitized voice data into packets for use in a packet switched network. Also, digitized voice data in packet form can be removed from the packet and converted back to analog voice. While voice digitizer 204 is shown as part of the PTT interworking agent 110 in FIG. 2, some or all of the functionality of the voice digitizer 204 can be implemented at the non-PTT enabled device 116.

Processor 206 can be any general purpose microprocessor, controller, or microcontroller that is suitably configured to control the operation of PTT interworking agent 110, or at least govern the processes described herein. In one embodiment, processor 206 determines the type of device accessing the PTT interworking agent 110 and can then determine the appropriate conversion needed for the signaling data. In one embodiment, once the processor 206 recognizes the calling party type, a database lookup can be done to determine what is needed to convert the incoming signals from the non-PTT enabled device 116 into the proper signals for the PTT server 106. For example, the processor 206 may determine the incoming call is from a POTS phone and that the conversion needs to be between DTMF and SIP. The information in the database associating the calling party type with additional information can be entered when the non-PTT user is registered as a user of the PTT interworking agent 110.

Memory 208 provides storage for data in support of PTT interworking agent 110 and can be realized as any processor-readable medium, including an electronic circuit, a semiconductor memory device, a ROM, a flash memory, an erasable ROM, a floppy diskette, a CD-ROM, an optical disk, a hard disk, an organic memory element, or the like. In one embodiment memory 208 includes a look up table or similar structure that can associate a destination address with a phone number. Also, memory 208 can store information associating the calling party type, such as protocols used, and the necessary conversions needed. Memory 208 can also be used to buffer packets of voice when needed.

Referring back to FIG. 1, the non-PTT enabled network 112 can be any telephone system that does not support PTT service and therefore, can not directly communicate with the PTT server 106. In one embodiment, the non-PTT enabled network 112 is the collection of interconnected systems operated by the various telephone companies and administrations around the world, known as the publicly switch telephone network (PSTN).

Non-PTT enabled devices 116 can be any device capable of providing telephone services over a circuit switched or packet switched network that does not, by itself, support PTT services. In a circuit switch embodiment, the non-PTT enabled device 116 can be a landline telephone, a cordless telephone, a computer communicating via the PSTN, a PBX system, an ISDN system and the like. In the present invention, since the non-PTT enabled device 116 does not include a push-to-talk button, which is pressed before a user speaks and released when the user is listening, the push-to-talk button can be emulated via any unused button (or sequence of button presses) on the phone, such as the “star-key” (*) or “pound-key” (#). Unlike normal PTT button operation, this will have the user activate an unused button to emulate pressing the PTT button to start the transmit session, and activate a second button sequence to end the transmit session, to emulate releasing the PTT button for a normal PTT device. Alternatively, the non-PTT enabled device 116 can utilize voice activated circuitry to detect voice activity and generate key press signals, and to detect voice inactivity and generate key release signals.

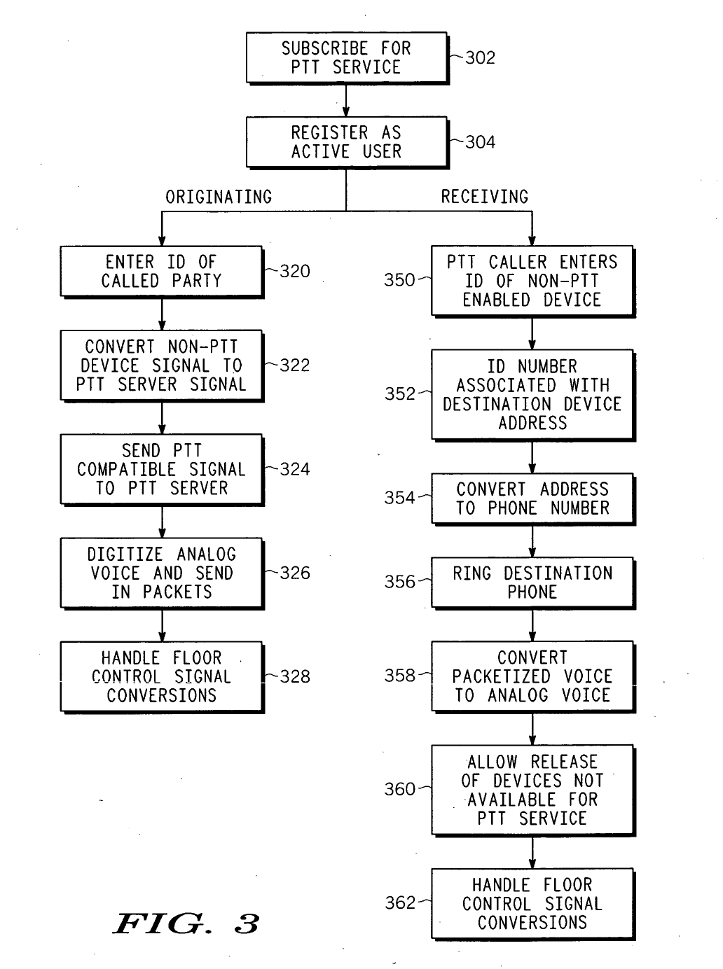

The present invention allows non-PTT enabled networks 112, such as those that use circuit switched devices, to participate in and originate PTT calls. FIG. 3 is a flowchart of an exemplary method for originating and terminating PTT calls from a POTS user. The user originating a PTT call from the POTS device is the POTS-PTT user.

In a first step, step 302, the POTS-PTT user subscribes for the PTT service. Typically, the POTS-PTT user subscribes for PTT interworking service at the PTT interworking agent 110. Once the POTS-PTT user has subscribed to the PTT service, a subscriber profile for the POTS-PTT user can be created that can include information such as the signaling protocol of the non-PTT enabled device 116. Additionally, data associated IP addresses assigned to POTS devices with the phone numbers of the POTS devices can also be stored in the profile. After the subscriber profile is complete, the POTS-PTT user is an authorized user.

After the POTS-PTT user subscribes to the PTT service, in step 304, the POTS-PTT user registers as an active subscriber. This step might be a temporary update to an existing subscription. Temporary registration can save memory and resources by storing information for only active subscribers. Registration can also be a permanent registration. Registration as an active subscriber stores information at the PTT server 106 that allows other registered PTT users to locate POTS user and POTS user to locate other registered PTT users. This information can be stored in a listing, table or other similar structure, such that an identification number entered by PTT users representing an user or group of users with which a PTT call is to be established is translated to a number or other information that can properly route signaling data and voice data. For example, the PTT user may enter a short identification number (or select a name from a listing associated with a number) representing another PTT user, in this case a POTS-PTT user. A table at the PTT server 106 can associate that number with an IP address assigned to the POTS device used by the POTS user.

Once the POTS-PTT user has subscribed to PTT service and is properly registered, PTT calls can either be originated or received by the POTS-PTT user. Origination of a PTT call is described in the flowchart of FIG. 3, starting at step 320. To initiate a PTT call, the identification number of the individual or group with whom the POTS-PTT user wishes to speak is entered at the POTS phone. This can be done in several ways. First, a group identification number could be dialed using the POTS phone. Or, two-stage dialing can be used. In two-stage dialing, a first telephone number is called and then an identification number can be entered. Other ways of entering an identification number corresponding to an individual or a group to initiate a PTT call can be used. At this step, when the PTT interworking agent 110 receives the call information such as the identification number, the call party type can be recognized, which determines what conversions are necessary for the signaling information and floor control signals.

The identification number entered will produce signals in a particular format. For example, as discussed previously, entering the identification number on a POTS device produces a DTMF signal. In step 322, the DTMF signal (or other signal protocol) indicative of the identification number of the destination phone or phones entered is converted to a SIP signal at PTT interworking agent 110. Next, in step 324, the SIP signal is received by the PTT server 106. The PTT server 106 will authenticate and authorize the POTS-PTT user, as is done for all PTT users. The PTT server 106 then examines the identification number which is associated with one or more destination phones. In one embodiment, the identification number is associated with an IP address of a cellular phone. The signaling information for the PTT call is routed to the proper phones based on the IP addresses, causing the phone or phones to produce an indication of an initiation of a PTT call, such as an audio indication, a visual indication, a tactile indication or a combination.

In addition to the routing of the signaling data, the voice data produced in the POTS-PTT call must also be routed to the correct phone or phones. First, the analog voice produced by the user of the circuit switched device is digitized and assembled into packets at PTT interworking agent 110 in step 326. If the call is a group call, the packets are duplicated and sent to all group members.

Once the call is established, in step 328, key press and key release sequences of the POTS-PTT user, which produce DTMF signals for floor control, are converted to RTCP signaling at the floor control signal converter 203. The PTT server 106 receives the RTCP signal and performs talker arbitration to determine which PTT user is the current speaker (who has the floor) and signals to all users the results of the arbitration.

The establishment of a PTT enabled cellular phone to POTS/PTT user call is illustrated in step 350 where the cellular PTT caller initially enters an identification number representing destination phones for a group PTT call and containing at least one PTT user currently registered with a circuit switched device (a non-PTT enabled user). Of course, the PTT caller could also initiate a non-group PTT call to a non-PTT enabled user. In step 352, the identification number is sent to the PTT server 106 where the identification number is associated with identification numbers of the destination device. Typically, this will be an IP address of the phone.

In step 354, in one embodiment, the PTT interworking agent 110 will convert this IP address to a phone number of the circuit switched device. This can be done by using a lookup table or similar structure stored in the memory 208 of the PTT interworking agent 110. Next, in step 356, the phone number is converted to a DTMF signal and sent over the PSTN. This will then cause the associated phone to produce an indication that a PTT call is coming.

Again, the voice data also must be sent to the destination phone. In step 358, digitized voice packets are converted to an analog voice signal at the PTT interworking agent 110 for delivery to the circuit switched device and sent over the PSTN for delivery to the circuit switched device.

If, once the signaling information reaches the POTS device, an answering machine, fax machine or other device incapable of participating in the PTT call answers, then, in step 360, the initiator of the PTT call may release the POTS device from the PTT call. This avoids joining a POTS device that can not participate in the PTT call. Additionally, if the user of the POTS device has not released the push-to-talk button, the call initiator can remotely deselect the push-to-talk button. In one embodiment, when the PTT interworking agent 110 is determining the type of device, the PTT interworking agent 110 can determine if the device is capable of supporting PTT services. If the device can not support PTT services, the device is never connected to a PTT call.

Once the call is established, in step 320, key presses and key releases made by the POTS-PTT user to request to talk or to switch to listening produces DTMF signals. These DTMF signals are converted to RTCP signals by the floor control signal converter 203. The RTCP signals are used by the PTT server 106 to perform floor control arbitration, which determines the speaking party and the listening parties.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed:

1. An interface for enabling push-to-talk service between push-to-talk enabled devices and non-push-to-talk enabled devices comprising:
an input configured to receive signaling information in a first signaling protocol and voice data from the non-push-to-talk enabled devices;
a means for converting the signaling information in the first signaling protocol to a second signaling protocol coupled to the input;
a means for converting the voice data to packetized voice data coupled to the input; and
an output coupled to the means for converting the signaling information and the means for converting the voice data, the output configured to send the signaling information in the second signaling protocol and the packetized voice data.

2. The interface of claim 1 wherein the signaling information in the first signaling protocol is a dual tone multi-frequency signal.

3. The interface of claim 1 wherein the second signaling protocol is a signaling protocol used in a push-to-talk server.

4. The interface of claim 3 wherein the second signaling protocol is Session Initiation Protocol.

5. The interface of claim 1 further comprising a processor coupled to the means for converting the signaling information and the means for converting the voice data, the processor configured to identify a calling party type.

6. The interface of claim 5 further comprising a memory coupled to the processor, the memory storing a table associating IP addresses associated with non-push-to-talk enabled devices to phone numbers of non-push-to-talk enabled devices.

7. The interface of claim 5 wherein the processor is further configured to query the memory to determine the first signaling protocol and the second signaling protocol and to provide the means for converting the signal information with the first signaling protocol and the second signaling protocol.

8. The interface of claim 1 further comprising a floor control signal converter coupled to the processor, the floor control signal converter configured to convert received floor signals from a first format to a second format.

9. The interface of claim 8 wherein the first format is dual tone multi-frequency and the second format is Real-Time Transmission Control Protocol.

10. The interface of claim 9 wherein the dual tone multi-frequency signal is generated by a key press on a circuit switched phone coupled to the interface, the key press indicating a desire to be the speaking party or to end transmission.

11. A method for providing push-to-talk service between a non-push-to-talk enabled device and a push-to-talk enabled device comprising;
registering the non-push-to-talk enabled device at a push-to-talk interworking agent;
receiving signaling data at the push-to-talk interworking agent in a first format, the signaling data including an identification number corresponding to a destination phone,
converting the signaling data in the first format to signaling data in a second format at the push-to-talk interworking agent; and
sending the push-to-talk signaling information in the second format to a push-to-talk server.

12. The method of claim 11 further comprising the steps of:
locating a destination address for the destination phone using the identification number; and
routing the signaling data in the second format to the destination phone using the destination address.

13. The method of claim 12 further comprising routing voice data packets from the non-push-to-talk enabled device to the destination phone using the destination address.

14. The method of claim 13 further comprising assembling the voice data into packets prior to the step of routing voice data packets.

15. The method of claim 11 where the step of receiving signaling data further comprises receiving a dual tone multi-frequency signal from a plain old telephone system telephone.

16. The method of claim 12 further comprising the step of:
receiving floor control signals at the push-to-talk interworking agent; and
converting the floor control signals from a first floor control protocol to a second floor control protocol.

17. A system for providing push-to-talk services for non-push-to-talk enabled devices comprising:
a push-to-talk server; and
a push-to-talk interworking agent coupled to the push-to-talk server and configured to convert signaling data in a first format received from the non-push-to-talk enabled device to a second format for use by the push-to-talk server.

18. The system of claim 17 wherein the push-to-talk interworking agent is further configured to convert voice data from the non-push-to-talk enabled device into voice data packets and to send the voice data packets to the push-to-talk server.

19. The system of claim 17 wherein the signaling data in the first format is a dual tone multi-frequency signal.

20. The system of claim 17 wherein the second format is session initiation protocol.

21. The system of claim 17 wherein the push-to-talk interworking agent comprising a processor configured to identify a calling party type.

22. The system of claim 21 wherein the push-to-talk interworking agent further comprising a memory coupled to processor, the memory storing a table associating IP addresses to phone numbers of non-push-to-talk enabled devices.

23. The system of claim 22 wherein the processor is further configured to query the memory to determine the first format and the second format for the calling party type.

24. The system of claim 17 further comprising a floor control signal converter coupled to the processor and configured to convert floor control signals from a first floor control format to a second control format.

25. The system of claim 24 wherein the first floor control format is a dual tone multi-frequency signal and the second floor control format is real-time control protocol.

26. The system of claim 25 wherein the dual tone multi-frequency signal is generated by a key press on a circuit switched phone coupled to the push-to-talk interworking agent, the key press indicating the floor is requested.

27. A method for providing push-to-talk service between a push-to-talk enabled device and a non-push-to-talk enabled device comprising;
registering the non-push-to-talk enabled device at a push-to-talk interworking agent;
receiving signaling data at the push-to-talk interworking agent from the push-to-talk enabled device in a first format, the signaling data including an identification number corresponding to a destination phone,
converting the signaling data in the first format to signaling data in a second format at the push-to-talk interworking agent;
associating the identification number of the destination phone with the telephone number of the destination phone; and
ringing the destination phone using the telephone number of the destination phone.

28. The method of claim 27 further comprising routing voice data packets from the push-to-talk enabled device to the push-to-talk interworking agent.

29. The method of claim 28 further comprising converting the voice data packets to analog voice and sending the analog voice to the destination phone.

30. The method of claim 27 wherein the step of receiving signaling data further comprises receiving signaling data in a Session Initiation Protocol from a push-to-talk server.

31. The method of claim 26 further comprising the step of:
receiving floor control signals at the push-to-talk interworking agent; and
converting the floor control signals from a first floor control protocol to a second floor control protocol.

32. The method of claim 31 wherein the step of converting the floor control signals from a first floor control protocol to a second floor control protocol further comprises converting from a Dual Tone Multi-Frequency signal to a Real-Time Transmission Control Protocol signal.
